(19) United States
(12) Patent Application Publication
(10) Pub. No.: US 2014/0345405 A1
(43) Pub. Date: Nov. 27, 2014

(54) Rsp-Gearing Insensitive to Axis Misalignment and Other Displacement and Methods of Producing Gears

(71) Applicant: Apex Brands, Inc., Apex, NC (US)

(72) Inventor: Stephen P. Radzevich, Lexington, SC (US)

(73) Assignee: APEX BRANDS, INC., Apex, NC (US)

(21) Appl. No.: 13/900,946

(22) Filed: May 23, 2013

(51) Int. Cl. F16H 55/08

(52) U.S. Cl. CPC F16H 55/08
USPC 74/412 R

(57) ABSTRACT

A gearing arrangement that includes a gear and a pinion with intermeshing teeth. The gear includes a base pitch and the pinion includes a base pitch. The geometry of the tooth flanks of the gear and the pinion are constructed to accommodate various values of axis misalignment. The base pitch of the gear is always equal to the operating base pitch of the gear pair. Similarly, the base pitch of the pinion is always equal to the operating base pitch of the gear pair. Therefore, the base pitches of the gear and pinion are always equal to one another and to the operating base pitch.

### BACKGROUND

The present application is directed to a design of precision gears that are insensitive to axis misalignment and other displacement including angular and linear displacements.

A gearing arrangement includes a gear with outwardly extending teeth that intermesh with corresponding teeth of a pinion. Different types of gearing arrangements include but are not limited to parallel-axis spur and helical gearing, intersected-axis gearing, and crossed-axis gearing.

Differences between base pitches of the gear and the pinion is a root cause for excessive noise excitation, low durability of gear boxes, and low power density through the gearing arrangement. Ideally, the gear and pinion are precisely manufactured such that the base pitches are equal. However, this is not feasible due to manufacturing errors. Further, the gearing arrangement will experience additional performance issues due to linear and angular displacements of tooth flanks when placed under load. Also, placement of the gear and pinion relative to each other may not be precise thus resulting in additional performance degradation.

Further issues may occur when the gears are not precisely aligned relative to each other. This misalignment may include both linear and angular displacements between the members. Manufacturing errors and elastic deformation of the shafts, housing, bearings, etc. are the main contributors to the resultant linear and angular displacements of the tooth flanks of the gears in many gearing arrangements.

In an ideal situation, the gears and pinions are precisely manufactured and aligned. However, this is often not the case when placed in use. Thus, there is a need for a precision gear arrangement that is insensitive to axis misalignment and other sources of linear and angular displacements.

### SUMMARY

The present application is directed to precision gearing arrangements that each include a gear and a pinion. The gears and pinions are configured to be insensitive to axis misalignment and other factors that could reduce the effectiveness of the arrangement.

One embodiment is directed to a gear set that includes a gear having a gear tooth flank and a gear base pitch, and a pinion having a pinion tooth flank and a pinion base pitch. The base pitches of the gear and the pinion are equal, and an operating base pitch of the gear and pinion is equal to the base pitches of the gear and pinion.

The gear set may include one of a parallel axis arrangement, an intersected-axis arrangement, and a crossed-axis arrangement.

The gear set may include that a line of contact between the gear and the pinion being a straight line that is entirely within a plane of action.

The gear set may include a line of contact between the gear and the pinion being a circular arc segment that is entirely within a plane of action.

The gear set may include a line of contact between the gear and the pinion being an arc of a cycloid curve that is entirely within a plane of action.

The gear set may include a line of contact that is a planar curve that is entirely within a plane of action.

Another embodiment is directed to a gear set that includes a gear having a plurality of teeth each with a gear tooth flank and a gear base pitch, and a pinion having a plurality of teeth each with a pinion tooth flank and a pinion base pitch. Geometries of the tooth flanks of the gear and pinion are constructed to accommodate axis misalignment with the base pitch of the gear always being equal to an operating base pitch of the gear and pinion pair.

The gear set may include the base pitch of the pinion always being equal to the operating base pitch of the gear and pinion pair.

The gear set may include one of a parallel axis arrangement, an intersected-axis arrangement, and a crossed-axis arrangement.

The gear set may include a line of contact between the gear and the pinion being a straight line that is entirely within a plane of action.

The gear set may include a line of contact between the gear and the pinion being a circular arc segment that is entirely within a plane of action.

The gear set may include a line of contact between the gear and the pinion being an arc of a cycloid curve that is entirely within a plane of action.

The gear set may include a line of contact being a planar curve that is entirely within a plane of action.

Another embodiment is directed to a gear set that includes a gear arrangement formed by a gear and a pinion. Geometries of the tooth flanks of the gear and the pinion are constructed to accommodate axis misalignment with the base pitch of the gear and the base pitch of the pinion each always being equal to an operating base pitch of the gear and pinion pair.

The gear set may include one of a parallel axis arrangement, an intersected-axis arrangement, and a crossed-axis arrangement.

The gear set may include a line of contact between the gear and the pinion being a straight line that is entirely within a plane of action.

The gear set may include a line of contact between the gear and the pinion is a circular arc segment being entirely within a plane of action.

The gear set may include a line of contact between the gear and the pinion being an arc of a cycloid curve that is entirely within a plane of action.

The gear set may include a line of contact being a planar curve that is entirely within a plane of action.

The various aspects of the various embodiments may be used alone or in any combination, as is desired.

### BRIEF DESCRIPTION OF THE DRAWINGS

FIG. 1 is a schematic view of a gear and a pinion in an ideal parallel axis arrangement.

FIG. 2 is a schematic view of a gear and a pinion illustrating the plane of action.

FIG. 3 is schematic view of a gear and a pinion illustrating a variety of tooth flank geometries.

FIG. 4 is a schematic view illustrating a deviation [symbol] _{n.g} is within a plane of action.

FIG. 5 is a schematic view illustrating a deviation [symbol] ⁿ_{τ.g} in a direction tangential to the gear/pinion tooth flank.

FIG. 6 is a schematic view illustrating a base line of a gear.

FIG. 7 is a schematic view illustrating a base line of a pinion.

FIGS. 8-10 are schematic views of a tooth flanks appearance.

FIG. 11 is a schematic view illustrating how the operating base pitch is measured in case of a parallel-axis gearing arrangement and zero axis misalignment.

FIG. 12 is a schematic view illustrating an operating base pitch.

FIG. 13 is a schematic view illustrating an operating base pitch.

FIG. 14 is a schematic view illustrating a straight line of contact within the plane of contact.

FIG. 15 is a schematic view illustrating a straight line of contact within the plane of contact.

FIG. 16 is a schematic view illustrating a line of contact that is a circular arc segment within the plane of contact.

FIG. 17 depicts a line of contact that is an arc of a cycloid curve within the plane of action.

FIG. 18 is a schematic view of cutting the gear illustrated in FIG. 14.

FIG. 19 is a schematic view of cutting the gear illustrated in FIG. 15.

FIG. 20 is a schematic view of cutting the gear illustrated in FIG. 16.

FIG. 21 is a schematic view of cutting the gear illustrated in FIG. 17.

### DETAILED DESCRIPTION

The present application is directed to a gearing arrangement that includes a gear and a pinion with intermeshing teeth. The gear includes a base pitch and the pinion includes a base pitch. The geometry of the tooth flanks of the gear and the pinion are constructed to accommodate various values of axis misalignment. The base pitch of the gear is always equal to the operating base pitch of the gear pair. Similarly, the base pitch of the pinion is always equal to the operating base pitch of the gear pair. Therefore, the base pitches of the gear and pinion are always equal to one another and to the operating base pitch.

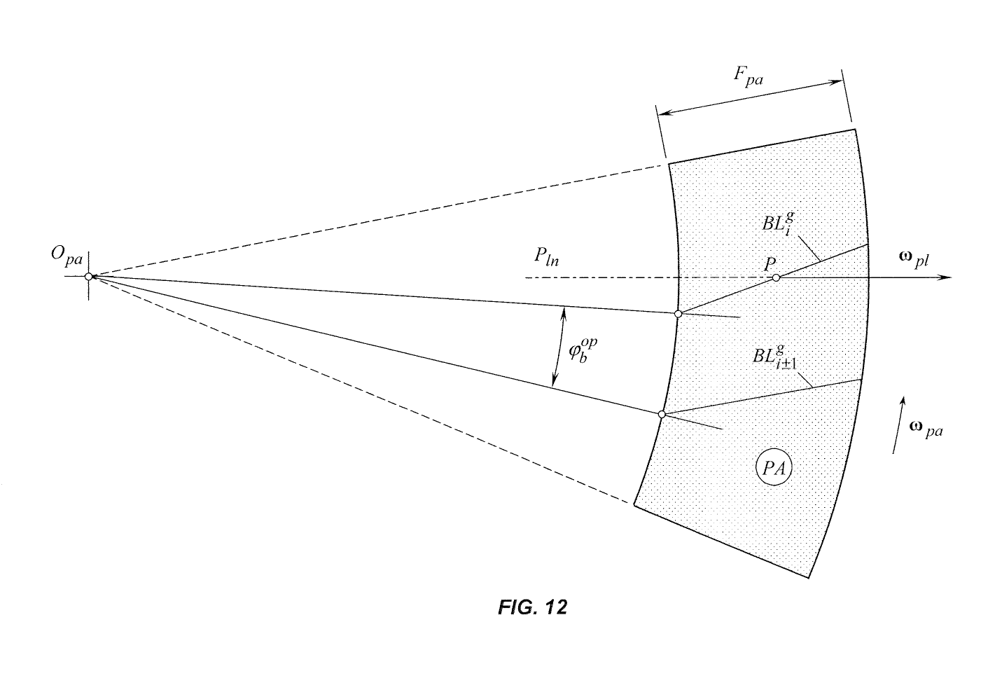

The base pitch of an ideal involute gear is commonly defined as the distance from one face of a tooth to the corresponding face of an adjacent tooth on the same gear, measured along the base circle. In order to define the operating base pitch of a real gear pair, that is, of a gear pair featuring certain linear displacement, and angular misalignment, it should be kept in mind that under displacement/misalignment gearing of all kinds (that is, parallel-axis gearing, intersected-axis gearing, and crossed-axis gearing) turns to a kind of crossed-axis gearing. Therefore, for real gearing, all three base pitches, namely, the base pitch of the gear, the base pitch of the pinion, and the operating base pitch of the gear pair, are expressed in terms of design parameters of a crossed-axis gearing. With that said, base pitch of a gear φ_{b.g} is an angular distance between the corresponding points of two adjacent teeth of the gear that is measured within the plane of action. Accordingly, base pitch of a pinion φ_{b.p} is an angular distance between the corresponding points of two adjacent teeth of the pinion that is measured within the plane of action. Ultimately, operating base pitch of a gear pair, φ_{b.op} (FIG. 12) is an angular distance between the corresponding points of two adjacent lines of contact that is measured within the plane of action.

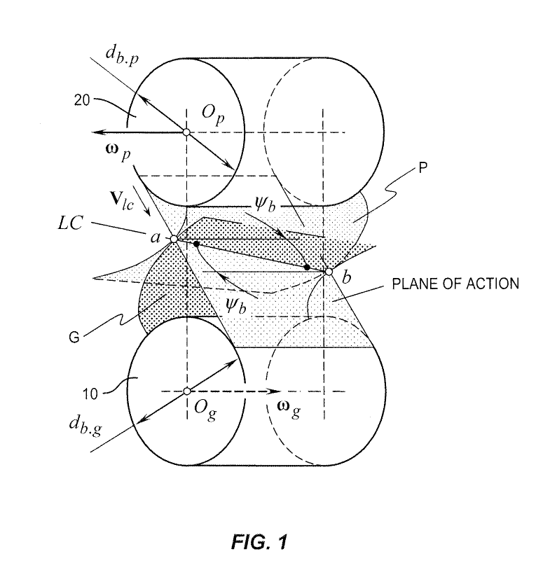

FIG. 1 illustrates a gear 10 and a pinion 20 of an ideal parallel-axis gearing arrangement. The gear 10 includes a base cylinder with a base diameter d_{b.g} and the pinion 20 includes a base cylinder of base diameter d_{b.p}. The base cylinders rotate about their axes of rotation O_{g} and Oₚ accordingly with rotation vectors ω_{g} and ωₚ indicating the directions of the rotations. A plane of action PA is formed between the members and is in tangency to both of the base cylinders. When the base cylinders rotate, the plane of action PA is unwrapping from the base cylinder of the driving pinion and is wrapping onto the base cylinder of the driven gear.

A straight line ab is entirely located within the plane of action PA. The line ab is at base helix angle ψ_{b}. When the base cylinders rotate, the line ab is traveling together with the plane of action PA. Vector V_{lc} is the velocity vector of the linear motion of the line ab.

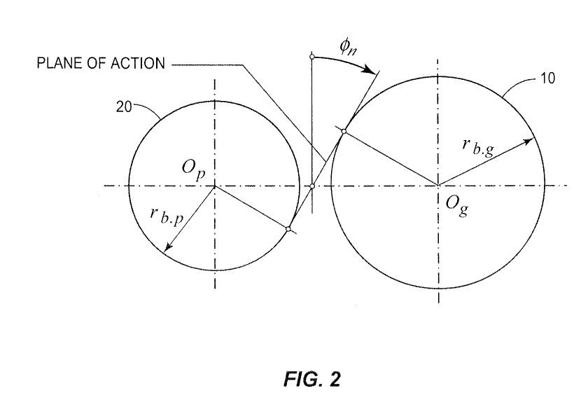

When traveling in relation to a reference system associated with the gear 10, a family of consecutive positions of the line ab represents the gear tooth flank G. Similarly, when traveling in relation to a reference system associated with the pinion 20, a family of consecutive positions of the line ab represents the pinion tooth flank P. Line ab can be interpreted either as the generation line for the tooth flanks G and P of the gear and of the pinion accordingly, or as the line of contact LC between the tooth flanks G and P. Both interpretations are correct. FIG. 2 includes a schematic representation to further identify the plane of action PA.

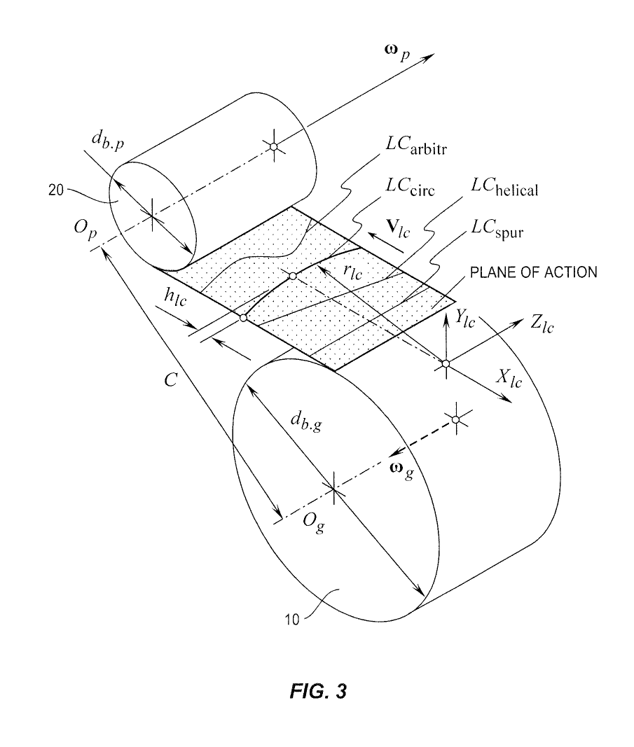

Similarly to the straight line ab illustrated in FIG. 1, planar curves of other geometries can be implemented for the purpose of generation of tooth flanks G, P of the gear 10 and of the pinion 20 in parallel axis gearing as illustrated in FIG. 3. This may include but is not limited to circular, helical, and arbitrary configurations.

For the derivation of an equation of the tooth flanks G and P, an equation of the line of contact LC is used. Initially this equation is commonly given in a reference system X_{lc}Y_{lc}Z_{lc} associated with the plane of action PA. In order to convert the equation of the line of contact LC to a corresponding equation of the gear tooth flank G, as well as to a corresponding equation of the pinion tooth flank P, operators of coordinate system transformation are used.

Then, position vector r_{g} of a point of the gear tooth flank G can be expressed by the equation:

r_{g}=Rs(LC→G)·r_{lc} (1)

Similarly, position vector rₚ of a point of the pinion tooth flank, P, can be expressed by the equation:

rₚ=Rs(LC→P)·r_{lc} (2)

The matrices Rs(LC→G) and Rs(LC→P) of the resultant coordinate system transformation can be composed as product of a certain number of the operators Tr(ax, X), Tr(ay, Y), Tr(az, Z) and Rt(φx, X), Rt(φy, Y), Rt(φz, Z) of elementary coordinate system transformation.

For the analytical description of the translation along the coordinate axes, the operators of translation Tr(ax, X), Tr(ay, Y) and Tr(az, Z) are used. The operators yield matrix representations in the form:

$$\begin{matrix}Tr ( {a}_{x} , X ) = [ \begin{matrix}1 & 0 & 0 & {a}_{x} \\ 0 & 1 & 0 & 0 \\ 0 & 0 & 1 & 0 \\ 0 & 0 & 0 & 1\end{matrix} ] & ( 3 ) \\ Tr ( {a}_{y} , Y ) = [ \begin{matrix}1 & 0 & 0 & 0 \\ 0 & 1 & 0 & {a}_{y} \\ 0 & 0 & 1 & 0 \\ 0 & 0 & 0 & 1\end{matrix} ] & ( 4 ) \\ Tr ( {a}_{z} , Z ) = [ \begin{matrix}1 & 0 & 0 & 0 \\ 0 & 1 & 0 & 0 \\ 0 & 0 & 1 & {a}_{z} \\ 0 & 0 & 0 & 1\end{matrix} ] & ( 5 )\end{matrix}$$

aₓ, a_{y}, and a_{z} are signed values that denote distances of translations along corresponding axes.

For the analytical description of the rotation about the coordinate axes, the operators of rotation Rt(φx, X), Rt(φy, Y) and Rt(φz, Z) are used. The operators yield representation in the form of the homogenous matrices:

$$\begin{matrix}Rt ( {ϕ}_{x} , X ) = [ \begin{matrix}1 & 0 & 0 & 0 \\ 0 & cos {ϕ}_{x} & sin {ϕ}_{x} & 0 \\ 0 & - sin {ϕ}_{x} & cos {ϕ}_{x} & 0 \\ 0 & 0 & 0 & 1\end{matrix} ] & ( 6 ) \\ Rt ( {ϕ}_{y} , Y ) = [ \begin{matrix}cos {ϕ}_{y} & 0 & - sin {ϕ}_{y} & 0 \\ 0 & 1 & 0 & 0 \\ sin {ϕ}_{y} & 0 & cos {ϕ}_{y} & 0 \\ 0 & 0 & 0 & 1\end{matrix} ] & ( 7 ) \\ Rt ( {ϕ}_{z} , Z ) = [ \begin{matrix}cos {ϕ}_{z} & sin {ϕ}_{z} & 0 & 0 \\ - sin {ϕ}_{z} & cos {ϕ}_{z} & 0 & 0 \\ 0 & 0 & 1 & 0 \\ 0 & 0 & 0 & 1\end{matrix} ] & ( 8 )\end{matrix}$$

Here, φx, φy, and φz, are signed values that denote angles of rotation about a corresponding axis: φx is an angle of rotation around the X-axis (pitch); φy is an angle of rotation around the Y-axis (roll), and φz is an angle of rotation around the Z-axis (yaw).

The above consideration relates to the ideal case of a parallel-axis gearing arrangement when the gear axis of rotation O_{g} and the pinion axis of rotation Oₚ are exactly parallel to one another and the axes of the rotations are remote from each other at a specified center distance C.

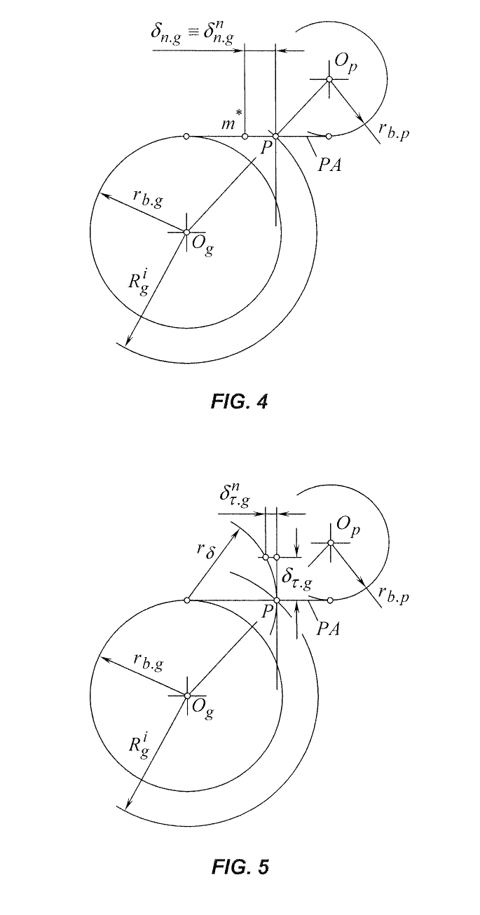

The impact of the resultant linear/angular displacements of the tooth flanks G and P in real parallel-axis gearing onto actual deviation of base pitch from the nominal value of it can be decomposed onto two components. One of the components is within the plane of action PA while another component is in the direction orthogonal to PA. FIG. 4 illustrates a case when the deviation [symbol] _{n.g} is within the plane of action PA. Due to this displacement [symbol] _{n.g}, the resultant displacement [symbol] ⁿ_{n.g} in the direction perpendicular to the tooth profile is identical to [symbol] _{n.g} , and the identity [symbol] ⁿ_{n.g}≡ [symbol] _{n.g} is valid.

As illustrated in FIG. 5, a deviation of that same value [symbol] _{τ.g} but in a direction tangential to the gear/pinion tooth flank results in a much smaller deviation [symbol] ⁿ_{τ.g}:

δn_{τ.g}ⁿ=r_{δ}−\sqrt{r_{δ}²−δ_{τ.g}²} (9)

This means that the component [symbol] _{n.g} in the direction within the plane of action PA is the major contributor to actual variation of the base pitch. In the gearing of the present application, the negligibly small component [symbol] ⁿ_{τ.g} of the resultant deviation is omitted. As a consequence, the proposed gearing features several advantages over known designs of gearing.

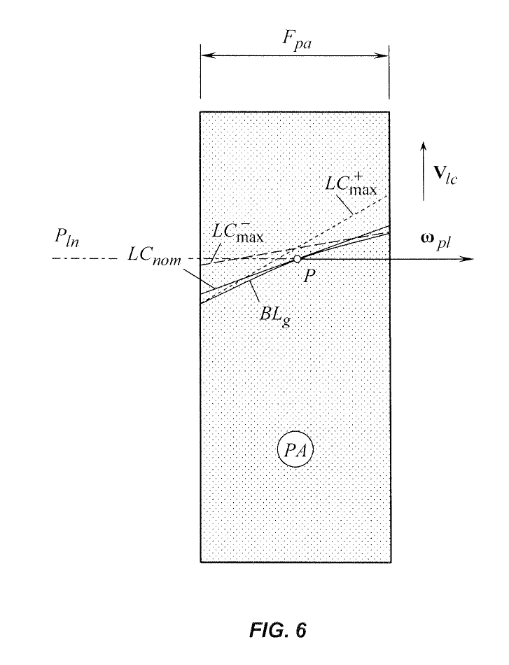

As an example, consider an involute helical gearing. A tooth flank G of an ideal helical involute gear is intersected by the plane of action PA along a straight line which is the line of contact LC between the gear and pinion tooth flanks G, P. In FIG. 6, the line of contact LC for an ideal helical involute gearing is labeled as LCₙₒₘ. In reality (due to manufacturing errors, due to displacements under the operating load, etc.), the actual line of contact is displaced from its nominal position. Maximum displacement of the line of contact LC in one of two possible directions is labeled as LCₘₐₓ₊, while maximum displacement of the line of contact in the opposite direction is labeled as LCₘₐₓ₋. Evidently, in reality, the desired nominal line of contact LCₙₒₘ could occupy certain intermediate positions and orientations somewhere either in between LCnom and LCₘₐₓ₊, or somewhere in between LCₙₒₘ and LCₘₐₓ₋. In this way a family of consecutive positions of the line of contact LC at different displacements can be constructed. Fₚₐ is the width of the plane of action, PA (i.e., the width within which face width of the gear F_{g} and face width of the pinion Fₚ overlap one another).

The base line of the gear BL_{g} is an envelope to consecutive positions of the desirable line of contact LCₙₒₘ when actual displacements in the gear pair are altering from its maximum value through zero deviations to maximum value of opposite sign. The base line of the gear BL_{g} is a planar curve that is entirely located within the plane of action PA. Position vector of a point of the base line of the gear BL_{g} is designated as r_{bl.g}.

The constructed base line of the gear BL_{g} is a generation line of the gear tooth flank G. Having the base line of the gear constructed, then position vector of a point r_{g.rm} of the gear tooth flank of the proposed gearing can be analytically described by the following expression:

r_{g.rm}=Rs(BL_{g}→G)·r_{bl.g} (10)

Similarly, the base line of the pinion BLₚ is an envelope to consecutive positions of the desirable line of contact LCₙₒₘ when actual displacements in the gear pair are altering from its maximum value through zero deviations to maximum value of opposite sign. The base line of the pinion BLₚ is a planar curve that is entirely located within the plane of action PA. Position vector of a point of the base line of the pinion BLₚ is designated as r_{bl.p}.

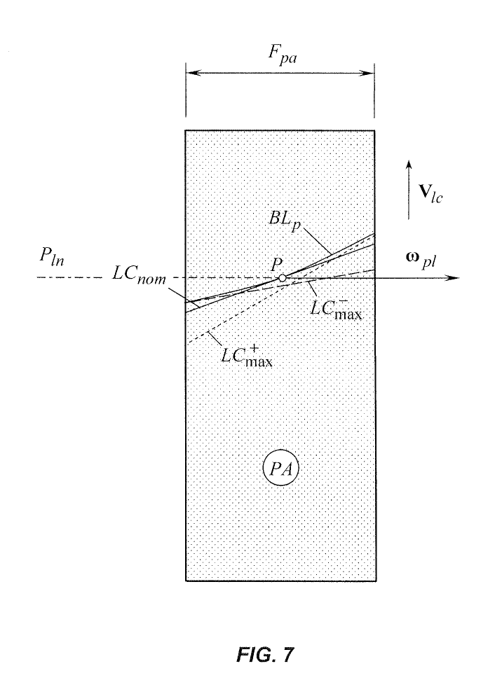

The constructed base line of the pinion BLₚ is a generation line of the pinion tooth flank, P as it is shown in FIG. 7. Having the base line of the pinion constructed, then position vector of a point r_{p.rm} of the pinion tooth flank P of the proposed gearing can be analytically described by the following expression:

r_{p.rm}=Rs(BLₚ→P)·r_{Bl.p} (11)

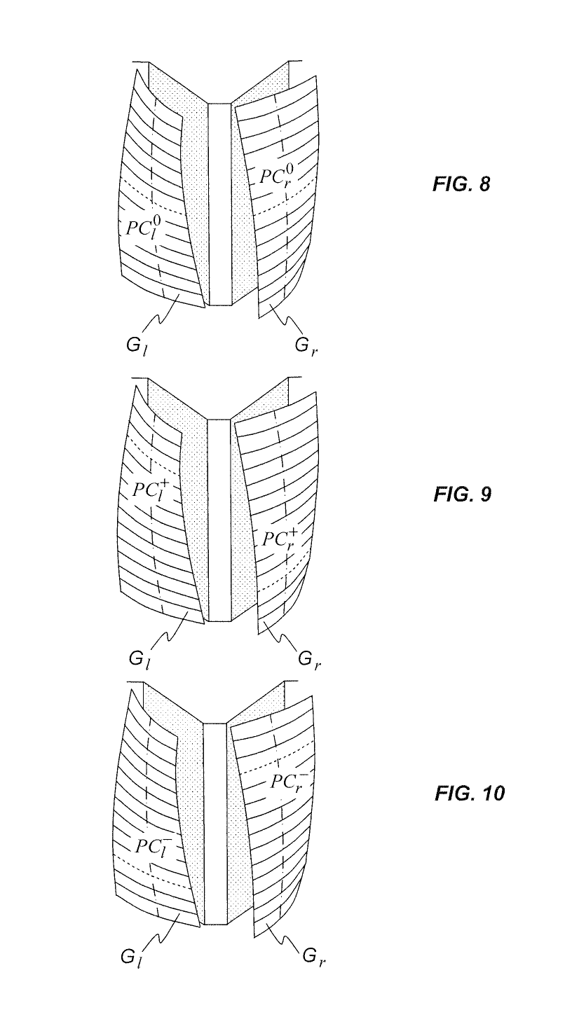

Gears having tooth flank geometry that meet the requirements [see Eq. (10) and Eq. (11)] are insensitive to the axis misalignment, as well as to tooth flank displacements caused by other reasons. At every instant, the gears make point contact between tooth flanks of the gear and of the mating pinion. The tooth flanks appearance is schematically shown in FIG. 8. The tooth flank of the left-side profile is labeled as Gₗ, and the tooth flank of the right-side profile is labeled as Gᵣ. When the gear and the pinion axes align, then paths of contact PCₗ⁰ and PCᵣ⁰ are spatial curves through the pitch point P.

As illustrated in FIG. 9, the paths of contact, PC₁⁺ and PCᵣ⁺ displace from their nominal location and configuration towards faces of the gear when the axis misalignment is maximum positive. As illustrated in FIG. 10, when the axis misalignment is maximum negative, then paths of contact, PCₗ⁻ and PCᵣ⁺ displace from their nominal location in opposite directions.

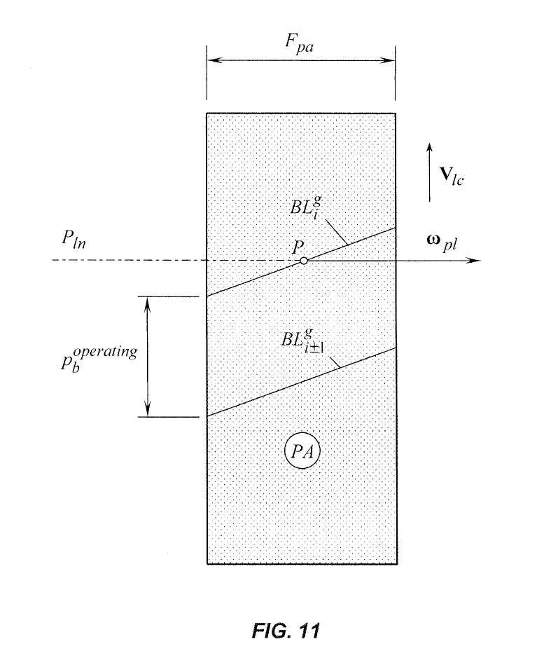

FIG. 11 illustrates how the operating base pitch P_{b}^{op} is measured in case of a parallel-axis gearing arrangement and zero axis misalignment which is in the ideal PA-gearing. In this particular case, the operating base pitch P_{b}^{op} is measured in linear units (mm, inches, etc.). In a general case of non-zero and zero axis misalignment in various gearing arrangements (e.g., intersected-axis, crossed-axis, parallel-axis), the operating base pitch φ_{b}^{op} is measured in angular units (degrees, radians, etc.).

In the gearing of the present application, the operating base pitch φ_{b}^{op} is indicated as an interval by which the entire tolerance on the axis misalignment in the gear pair is covered. The larger the axis misalignment, the larger the actual value of the operating base pitch φ_{b}^{op} (see FIG. 12).

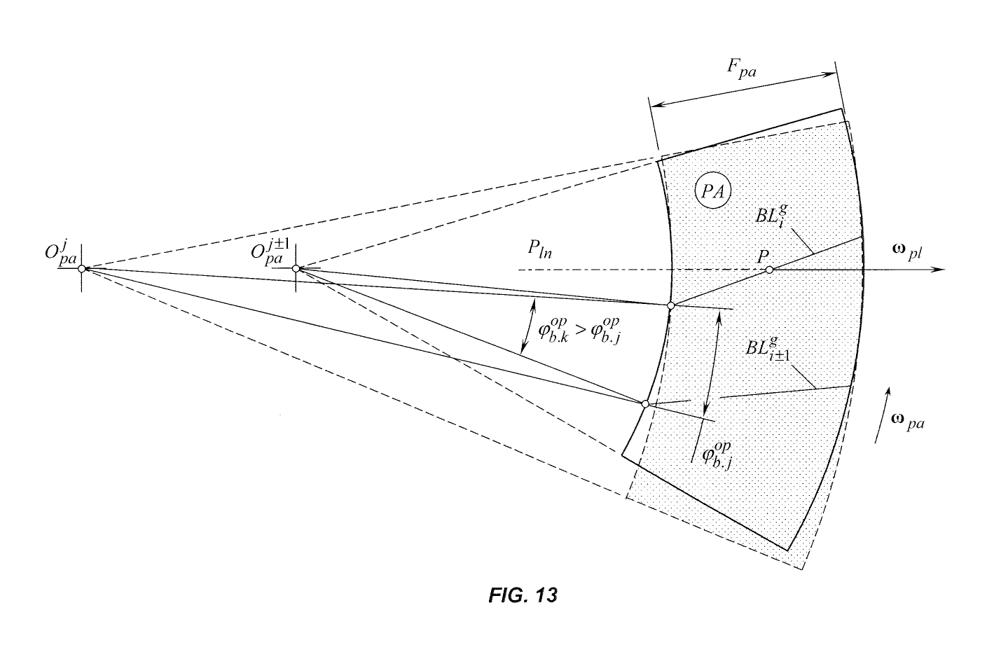

Actual values of the linear displacement and of angular misalignment are not known. However, both the displacement and the misalignment are such that they do not exceed the corresponding tolerances of the displacement and the misalignment. The tolerances are known, as they can be calculated. In order to accommodate for the displacements and misalignments within the corresponding tolerances, the tolerance for the base pitch is equal to (or slightly overlaps) its deviations caused by actual displacement and misalignment. Impact of the displacements/misalignments onto variation of the base pitch is illustrated in FIG. 13.

The geometry of the gear and pinion tooth flanks G, P in the aspects of the present application (as illustrated in FIGS. 8-10) is capable of accommodating for various values of the axis misalignment. In this way, the base pitch of the gear is always equal to the operating base pitch φ_{b}^{op} of the gear pair. Similarly, the base pitch of the pinion is always equal to the operating base pitch φ_{b}^{op} of the gear pair. Ultimately, the base pitches of the gear and of the mating pinion are always equal to one another (and to the operating base pitch as well). In this way, the fundamental law of gearing is satisfied under the values of the displacements/misalignments.

In the various embodiments, the line of contact LC may be any planar curve that is entirely within the plane of action PA. The geometry of the line of contact LC may be chosen based on manufacturing considerations/preferences. For example, a line of contact LC that ensures a low cost manufacturing technique may be utilized. In one embodiment, the line of contact LC is chosen so that a gear cutting tool having a zero profile angle (α_{cutter}=0°) is used to manufacture the gear set.

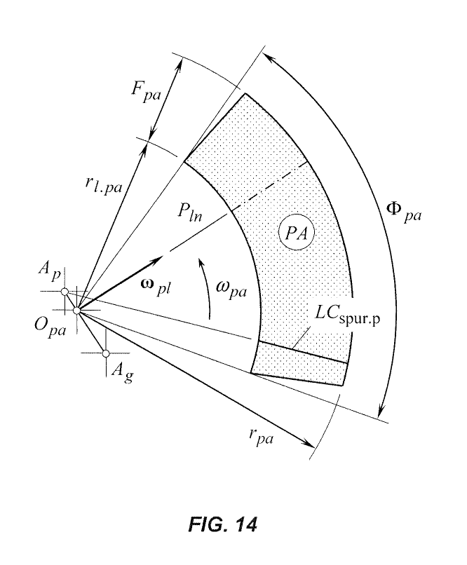

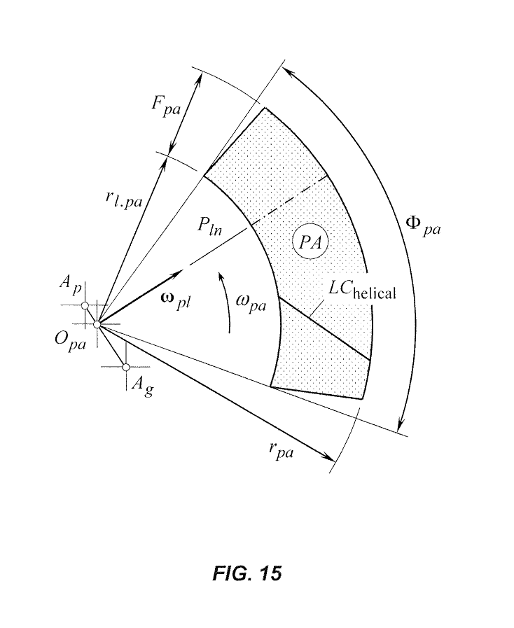

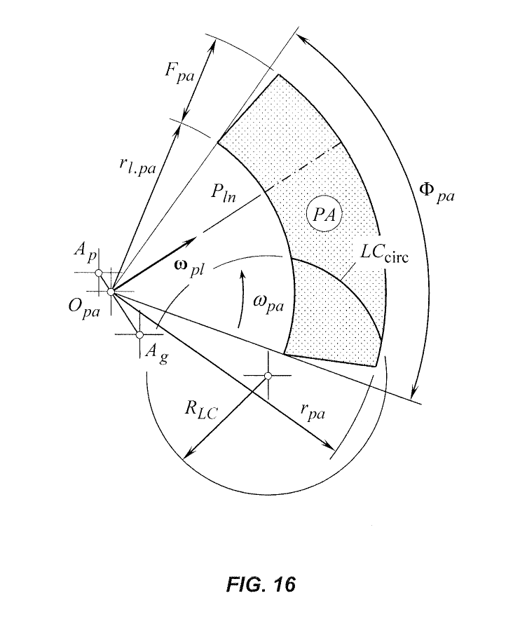

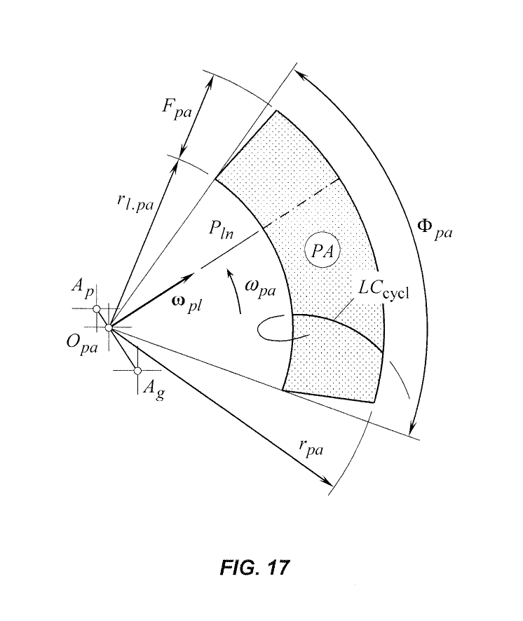

FIGS. 14-17 illustrate various kinds of line of contact that fall within the scope of the aspects disclosed in the present application. FIG. 14 depicts a straight line of contact LC_{spur.p} within the plane of action PA which may be utilized to form a spur gear. The straight line of contact LC allows planing gear cutting tools to be utilized to produce the gear. FIG. 15 depicts a straight line of contact LC_{helical} within the plane of action PA which may be utilized to form a helical gear. The straight line of contact LC allows planing gear cutting tools to be utilized to produce the gear. FIG. 16 depicts a line of contact LC_{circ} that is a circular arc segment within the plane of action PA. The circular arc line of contact LC allows face milling cutters to be utilized to manufacture the gear. FIG. 17 depicts a line of contact LC that is an arc of a cycloid curve LC_{cycl} within the plane of action PA. The cycloid arc line of contact allows face hobs to be utilized to manufacture the gear.

The geometry of the line of contact LC is not limited to straight line segments, circular arc segments, and cycloid arc segments. Any planar curve that is located entirely within the plane of action PA may be utilized for the purpose of producing a worm gear set with a reduced noise and vibration characteristic, and an increased loading capacity.

The various lines of contact within the plane of action PA illustrated in FIGS. 14-17 provide an insight into how the gears of the proposed design can be cut on conventional gear generators. The gears may be cut from a gear body 110 by a cutter 100 that traces the base line of the gear BL_{g} within the plane of action PA. It is understood that the cutting of the pinions is identical to that for the gears.

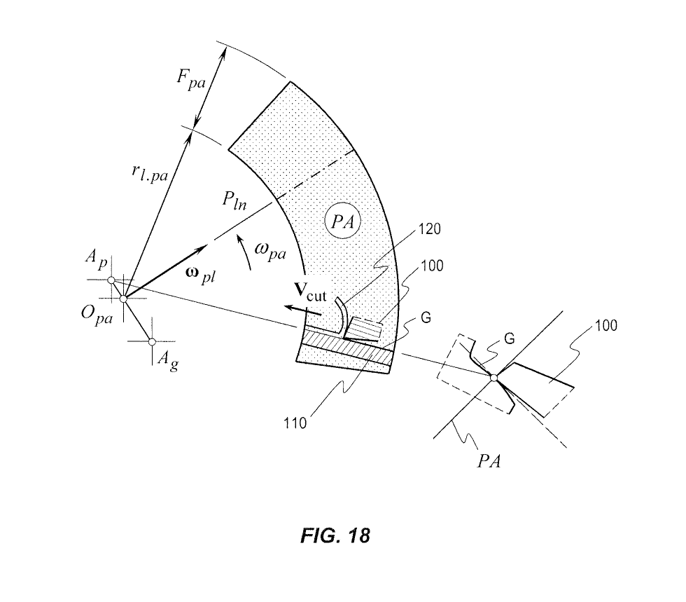

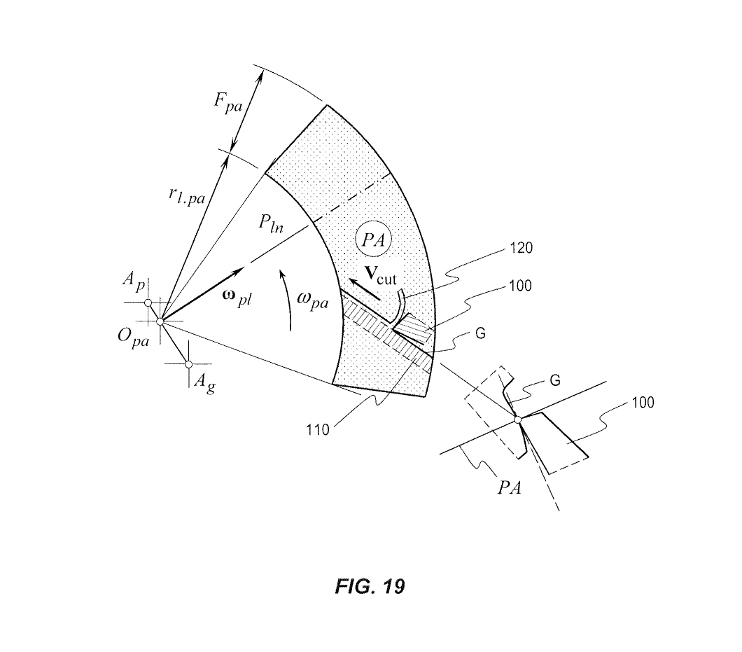

FIG. 14 includes straight bevel gears of the proposed design that can be cut in the gear body 110 as schematically illustrated in FIG. 18. FIG. 18 includes a chip 120 being cut from the gear tooth body 110. The cutter 100 is moved straight to form a cut V_{cut} with the nose of the cutter 100 tracing the base line of the gear BL_{g} within the plane of action PA. Simultaneously with this motion, the gear body 110 is rotated so that the base cone of the gear is rolling with no sliding over the plane of action PA. After the machining of one gear tooth flank G is complete, the work-gear is indexed, and then the tooth flank of the next gear is machined until all the teeth flanks are machined. In the various embodiments, a portion of the cutting edge in the vicinity of the cutter “nose” can be either rounded or faceted in order to improve the cutting conditions. Under any circumstances, the gear tooth flank G is generated by the point. In FIGS. 19-21, this point is illustrated as a small size circle that is centering at the point of intersection of the tangent to the tooth profile and the straight line labeled as PA.

FIG. 15 illustrates a skew bevel gear of the proposed design that can be cut as schematically illustrated in the attached FIG. 19. The cutter 100 is moved straight as illustrated by V_{cut} and the nose of the cutter 100 traces the base line of the gear BL_{g} within the plane of action PA. Simultaneously with this motion, the gear body 110 rotated so that the base cone of the gear is rolling with no sliding over the plane of action PA. After machining of one gear tooth flank is complete, the work-gear body 110 is indexed, and then the tooth flank of the next gear is machined until all the teeth flanks are machined.

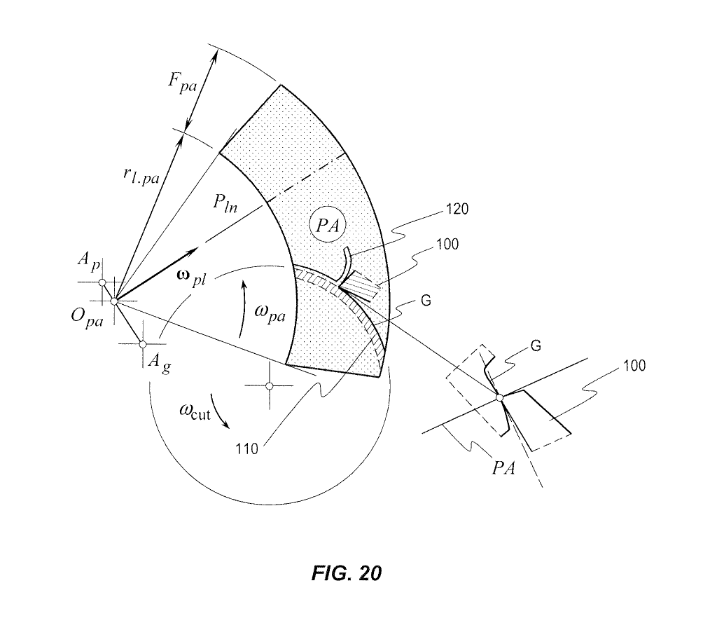

FIG. 16 illustrates a spiral bevel gear of the proposed design that can be cut as schematically illustrated in FIG. 20. The milling cutter 100 is rotated ω_{cut} and the nose of the milling cutter blade 100 traces the base line of the gear BL_{g} within the plane of action PA. Simultaneously with this motion, the gear body 110 is rotated so that the base cone of the gear is rolling with no sliding over the plane of action PA. After machining of one gear tooth flank is complete, the work-gear 110 is indexed, and then the tooth flank of the next gear is machined until all the teeth flanks are machined.

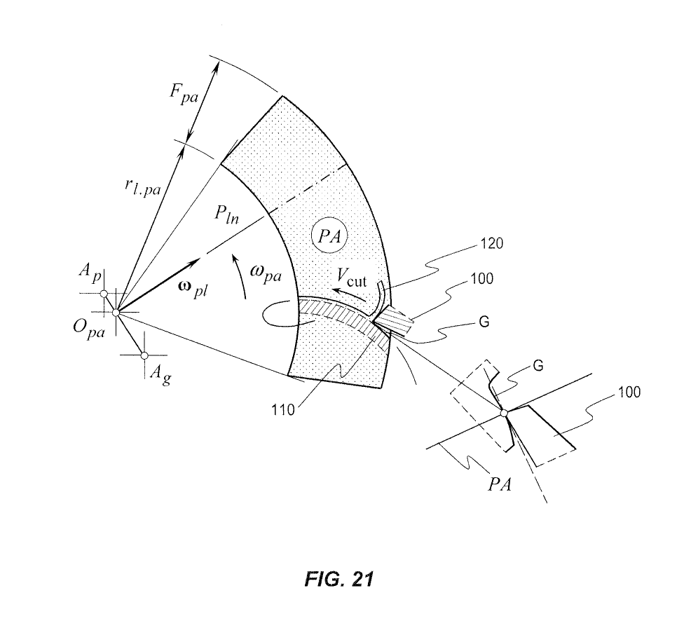

FIG. 17 illustrates a spiral bevel gear of the proposed design that can be cut as schematically illustrated in FIG. 21. The face hob is rotated ω_{cut} and the nose of the face hob blade 100 traces the base line of the gear BL_{g} within the plane of action PA. Simultaneously with this motion, the gear body 110 is rotated so that the base cone of the gear is rolling with no sliding over the plane of action PA. The machining is performing under continuously indexing. Therefore, no indexing of the work-gear is required, and tooth flanks of all the teeth are machined simultaneously.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A gear set comprising:
a gear having a gear tooth flank and a gear base pitch;
a pinion having a pinion tooth flank and a pinion base pitch;
the base pitches of the gear and the pinion are equal;
an operating base pitch of the gear and pinion is equal to the base pitches of the gear and pinion.

2. The gear set of claim 1, wherein the gear set includes one of a parallel axis arrangement, an intersected-axis arrangement, and a crossed-axis arrangement.

3. The gear set of claim 1, wherein a line of contact between the gear and the pinion is a straight line that is entirely within a plane of action.

4. The gear set of claim 1, wherein a line of contact between the gear and the pinion is a circular arc segment that is entirely within a plane of action.

5. The gear set of claim 1, wherein a line of contact between the gear and the pinion is an arc of a cycloid curve that is entirely within a plane of action.

6. The gear set of claim 1, wherein a line of contact is a planar curve that is entirely within a plane of action.

7. A gear set comprising:
a gear having a plurality of teeth each with a gear tooth flank and a gear base pitch;
a pinion having a plurality of teeth each with a pinion tooth flank and a pinion base pitch;
geometries of the tooth flanks of the gear and pinion being constructed to accommodate axis misalignment with the base pitch of the gear always being equal to an operating base pitch of the gear and pinion pair.

8. The gear set of claim 7, wherein the base pitch of the pinion always being equal to the operating base pitch of the gear and pinion pair.

9. The gear set of claim 7, wherein the gear set includes one of a parallel axis arrangement, an intersected-axis arrangement, and a crossed-axis arrangement.

10. The gear set of claim 7, wherein a line of contact between the gear and the pinion is a straight line that is entirely within a plane of action.

11. The gear set of claim 7, wherein a line of contact between the gear and the pinion is a circular arc segment that is entirely within a plane of action.

12. The gear set of claim 7, wherein a line of contact between the gear and the pinion is an arc of a cycloid curve that is entirely within a plane of action.

13. The gear set of claim 7, wherein a line of contact is a planar curve that is entirely within a plane of action.

14. A gear set comprising:
a gear arrangement formed by a gear and a pinion;
geometries of the tooth flanks of the gear and the pinion being constructed to accommodate axis misalignment with the base pitch of the gear and the base pitch of the pinion each always being equal to an operating base pitch of the gear and pinion pair.

15. The gear set of claim 14, wherein the gear set includes one of a parallel axis arrangement, an intersected-axis arrangement, and a crossed-axis arrangement.

16. The gear set of claim 14, wherein a line of contact between the gear and the pinion is a straight line that is entirely within a plane of action.

17. The gear set of claim 14, wherein a line of contact between the gear and the pinion is a circular arc segment that is entirely within a plane of action.

18. The gear set of claim 14, wherein a line of contact between the gear and the pinion is an arc of a cycloid curve that is entirely within a plane of action.

19. The gear set of claim 14, wherein a line of contact is a planar curve that is entirely within a plane of action.
